(19) United States
(12) Patent Application Publication
(10) Pub. No.: US 2022/0261174 A1
(43) Pub. Date: Aug. 18, 2022

(54) MEMORY SYSTEM

(71) Applicant: Kioxia Corporation, Tokyo (JP)

(72) Inventors: Shunichi IGAHARA, Fujisawa Kanagawa (JP); Yoshihisa KOJIMA, Kawasaki Kanagawa (JP); Takehiko AMAKI, Yokohama Kanagawa (JP); Suguru NISHIKAWA, Arakawa Tokyo (JP)

(73) Assignee: Kioxia Corporation, Tokyo (JP)

(21) Appl. No.: 17/368,587

(22) Filed: Jul. 6, 2021

(30) Foreign Application Priority Data
Feb. 12, 2021 (JP) 2021-021179

(51) Int. Cl. G06F 3/06

(52) U.S. Cl. CPC G06F 3/0655; G06F 3/0679; G06F 3/0604; G06F 3/0629

(57) ABSTRACT

According to one embodiment, a memory system includes a non-volatile memory, and a memory controller. The memory controller receives a write request for data, and determines a unit of a logical-to-physical address conversion which is a conversion between a logical address associated with the data and a physical address of the non-volatile memory into which the data is to be written, according to a size of the data.

### CROSS-REFERENCE TO RELATED APPLICATION(S)

This application is based upon and claims the benefit of priority from Japanese Patent Application No. 2021-021179, filed Feb. 12, 2021, the entire contents of which are incorporated herein by reference.

### FIELD

Embodiments described herein relate generally to a memory system.

### BACKGROUND

For a non-volatile memory, an upper limit for the number of write operations is defined. The lifetime of a memory system provided with the non-volatile memory is defined based on a predetermined workload. The predetermined workload is determined by standards or customer requirements.

However, when an access pattern in the actual use of the memory system is different from an access pattern in the predetermined workload, the lifetime of the memory system may become shorter than the lifetime defined by the standards or customer requirements.

### DESCRIPTION OF THE DRAWINGS

FIG. 1 is a block diagram illustrating a configuration of a memory system according to a first embodiment.

FIG. 2 is a block diagram illustrating a lifetime optimizing process according to the first embodiment.

FIG. 3 is a block diagram illustrating a lifetime optimizing process according to a modification of the first embodiment.

FIG. 4 is a flowchart illustrating an example of a procedure of a write management unit setting process performed by a processor according to the first embodiment.

FIG. 5 is a flowchart illustrating another example of a procedure of the write management unit setting process performed by the processor according to the first embodiment.

FIG. 6 is a view illustrating a data write operation when an access size is smaller than a write management unit according to the first embodiment.

FIG. 7 is a view illustrating a data connecting process according to the first embodiment.

FIG. 8 is a block diagram illustrating a lifetime optimizing process according to a second embodiment.

FIG. 9 is a block diagram illustrating a lifetime optimizing process according to a modification of the second embodiment.

FIG. 10 is a view illustrating an example of a relation between an access range and a write mode according to the second embodiment.

FIG. 11 is a view illustrating another example of the relation between the access range and the write mode according to the second embodiment.

FIG. 12 is a flowchart illustrating an example of a procedure of a write mode setting process performed by a processor according to the second embodiment.

FIG. 13 is a flowchart illustrating an example of a procedure of a write mode setting process performed by a processor according to a third embodiment.

FIG. 14 is a block diagram illustrating a lifetime optimizing process according to a fourth embodiment.

FIG. 15 is a flowchart illustrating an example of a procedure of a flush process performed by a processor according to the fourth embodiment.

FIG. 16 is a flowchart illustrating an example of a procedure of a flush process performed by a processor according to a modification of the fourth embodiment.

### DETAILED DESCRIPTION

Embodiments provide a memory system capable of optimizing the lifetime thereof according to an access pattern.

In general, according to one embodiment, a memory system includes a non-volatile memory and a memory controller. The memory controller receives a write request for data, and determines a unit of a logical-to-physical address conversion which is a conversion between a logical address associated with the data and a physical address of the non-volatile memory into which the data is to be written, according to a size of the data.

Hereinafter, embodiments of the present disclosure will be described with reference to the drawings.

### First Embodiment

A memory system according to a first embodiment will be described. In the descriptions herein below, a memory system provided with a NAND type flash memory will be described as an example.

1. Configuration

[Entire Configuration of Memory System]

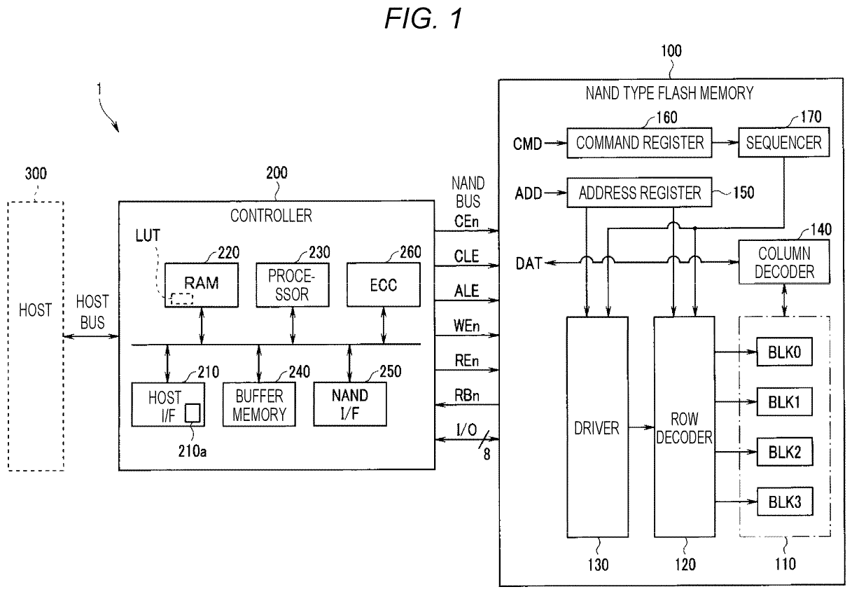

An example of a configuration of a memory system according to the present embodiment will be described using FIG. 1.

FIG. 1 is a block diagram illustrating the configuration of the memory system according to the present embodiment. A memory system 1 is a storage device that includes a non-volatile memory 100 and a memory controller 200 (hereinafter, also simply referred to as a controller). Here, the non-volatile memory 100 is a NAND type flash memory. The non-volatile memory 100 and the controller 200 are formed on, for example, one substrate. The storage device is, for example, a memory card such as an SD card, or an SSD (solid state drive).

The controller 200 is implemented by, for example, a system-on-a-chip (SoC). The function of each unit of the controller 200 may be implemented by dedicated hardware, a processor that executes a program (firmware), or a combination thereof.

The controller 200 is connected to the non-volatile memory 100 via a NAND bus. The NAND bus is a bus that is used to transmit/receive signals according to a NAND interface. The controller 200 controls the non-volatile memory 100.

The controller 200 is connected to a host device 300 (indicated by a dotted line) via a host bus. The host device 300 is, for example, a digital camera, a mobile phone, a server, or a personal computer. The host bus is a bus that corresponds to, for example, an SD interface. The controller 200 accesses the non-volatile memory 100 in response to a request received from the host device 300.

The non-volatile memory 100 is a semiconductor storage device that includes multiple memory cells. The multiple memory cells are able to store data in a non-volatile manner. Each memory cell is able to store 1-bit or multi-bit data. Hereinafter, the number of bits that may be stored in each memory cell will be referred to as a multi-value degree. Here, each memory cell is used as any of a penta level cell (PLC), a quad level cell (QLC), a triple level cell (TLC), a multi-level cell (MLC), and a single level cell (SLC). The PLC is able to store 5-bit data per memory cell. The QLC is able to store 4-bit data per memory cell. The TLC is able to store 3-bit data per memory cell. The MLC is able to store 2-bit data per memory cell. The SLC is able to store 1-bit data per memory cell. As described later, the non-volatile memory 100 includes multiple blocks BLK. For example, for each block BLK, data is written in any write mode among the PLC, QLC, TLC, MLC, SLC modes.

The NAND bus includes a chip enable signal CEn, a command latch enable signal CLE, an address latch enable signal ALE, a write enable signal WEn, a read enable signal REn, a ready/busy signal RBn, and an input/output signal I/O. The chip enable signal CEn, the command latch enable signal CLE, the address latch enable signal ALE, the write enable signal WEn, and the read enable signal REn are supplied from the controller 200 to the non-volatile memory 100. The ready/busy signal RBn is supplied from the non-volatile memory 100 to the controller 200. The input/output signal I/O is transmitted/received between the controller 200 and the non-volatile memory 100.

The chip enable signal CEn is a signal for enabling the non-volatile memory 100, and is asserted at a low level. The command latch enable signal CLE and the address latch enable signal ALE are signals for notifying the non-volatile memory 100 that input/output signals I/O are a command and an address, respectively. The write enable signal WEn is asserted at a low level, and is a signal for notifying the non-volatile memory 100 that an input/output signal I/O is written into the non-volatile memory 100. The read enable signal REn is also asserted at a low level, and is a signal for outputting data read from the non-volatile memory 100 to the input/output signal I/O. The ready/busy signal RBn indicates whether the non-volatile memory 100 is in a ready state (a state where the non-volatile memory 100 is able to receive a command from the controller 200) or in a busy state (a state where the non-volatile memory 100 is unable to receive a command from the controller 200), and indicates the busy state at the low level. The input/output signal I/O is, for example, an 8-bit signal. The input/output signal I/O is information transmitted/received between the non-volatile memory 100 and the controller 200, and is a command, an address, write data or read data or the like.

[Configuration of Controller]

Subsequently, details of the configuration of the controller 200 will be described. The controller 200 is a circuit provided with a host interface (I/F) circuit 210, a random access memory (hereinafter, referred to as a RAM) 220, a processor 230 including a central processing unit (CPU), a buffer memory 240, a NAND interface (I/F) circuit 250, and an error checking and correcting (ECC) circuit 260.

The host I/F circuit 210 is connected to the host device 300 via the host bus. The host I/F circuit 210 transmits a request and data received from the host device 300 to each of the processor 230 and the buffer memory 240. Further, the host I/F circuit 210 transmits data in the buffer memory 240 to the host device 300 in response to an instruction from the processor 230. The host I/F circuit 210 includes an access pattern information reception circuit 210a. Details of the access pattern information reception circuit 210a will be described later.

The RAM 220 is, for example, a semiconductor memory such as a static RAM (SRAM), and is used as a work area of the processor 230. Further, the RAM 220 stores firmware for managing the non-volatile memory 100, and management information MI. The firmware or the management information MI is read from a predetermined storage area of the non-volatile memory 100 and stored in the RAM 220, for example, when the memory system 1 is started up. The management information MI includes, for example, a logical-to-physical address conversion table (also referred to as a look-up table LUT) and shift table information. The LUT will be described later. The shift table information is information for shifting a data read level (i.e., data read voltage) when the controller 200 executes a process of reading data from the non-volatile memory 100.

The processor 230 controls the entire operation of the controller 200. For example, when a data read request is received from the host device 300, the processor 230 issues a read command to the NAND I/F circuit 250 in response. When a data write request and a data erase request are received from the host device 300, the processor 230 also issues commands that respond to the received requests, to the NAND I/F circuit 250. Further, the processor 230 executes various processes for managing the non-volatile memory 100 such as a wear-leveling.

The LUT stores information for converting a logical address of data related to an access request from the host device 300, into a physical address of the non-volatile memory 100. For example, the LUT can be used to perform a logical-to-physical address conversion. The processor 230 refers to the LUT to convert a logical address from the host device 300 into a physical address.

The processor 230 stores and manages address information in units of a cluster in the LUT. The cluster is the smallest unit of the conversion from a logical address into a physical address. In other words, the cluster is a write management unit WMU of data in the controller 200.

The management of the LUT in units of a cluster is disclosed in U.S. patent application Ser. No. 15/267,734 filed on Sep. 16, 2016 and entitled “MEMORY SYSTEM INCLUDING A CONTROLLER AND A NON-VOLATILE MEMORY HAVING MEMORY BLOCKS”. The disclosures in the US patent application are incorporated herein in its entirety by reference.

Meanwhile, in the non-volatile memory 100, a write operation and a read operation of data are performed in units of a page. User data is written into a designated page of a block BLK instructed by the processor 230. The page has a size “m” times the size of the cluster (m is a positive integer).

As described above, the processor 230 manages user data in units of a cluster. Meanwhile, the write operation of user data into the non-volatile memory 100 is performed in units of a page. In the LUT, information on a logical-to-physical address conversion is stored based on the write management unit WMU (i.e., in units of a cluster size).

When a write request of user data in a size equal to or smaller than the cluster size is received, the processor 230 converts the logical address of the user data into a physical address. The processor 230 generates data in a page size (page data) that includes the user data. At this time, the processor 230 generates the page data by combining the user data in the size equal to or smaller than the cluster size, with other user data already written in a page that corresponds to the physical address obtained as a result of the conversion. The processor 230 writes the generated page data that includes the user data, into the non-volatile memory 100. The processor 230 determines a physical address that includes a page address where the page data is written (including a block ID and a page address). The processor 230 updates the LUT such that the logical address of the user data is associated with the determined physical address.

As described later, in the present embodiment, the controller 200 makes the cluster size conform to the access size of the host device 300 (e.g., the size of user data related to a write request). Specifically, the cluster size is set to conform to an access size designated by access pattern information from the host device 300. Alternatively, the cluster size is set to conform to an access size obtained by analyzing a write request from the host device 300. In the LUT, information of a corresponding relation between a logical address and a physical address is stored in the cluster size that conforms to the access size.

The buffer memory 240 is, for example, a semiconductor memory such as a dynamic RAM (DRAM). The buffer memory 240 may be provided outside the controller 200. The buffer memory 240 is a volatile data buffer capable of temporarily storing write data and read data. User data related to a write request from the host device 300 is temporarily stored in the buffer memory 240. User data related to a read request from the host device 300 is read from the non-volatile memory 100, and temporarily stored in the buffer memory 240.

The NAND I/F circuit 250 is connected to the non-volatile memory 100 via the NAND bus. The NAND I/F circuit 250 performs a communication between the controller 200 and the non-volatile memory 100. The NAND I/F circuit 250 includes a write interface 250a and a read interface 250b. Further, the NAND I/F circuit 250 outputs various signals including a command and data, to the non-volatile memory 100, based on an instruction from the processor 230. Further, the NAND I/F circuit 250 receives various signals including a status and data from the non-volatile memory 100.

Specifically, based on an instruction from the processor 230, the NAND I/F circuit 250 outputs the chip enable signal CEn, the command latch enable signal CLE, the address latch enable signal ALE, the write enable signal WEn, and the read enable signal REn, to the non-volatile memory 100. Further, during a data write operation, the NAND I/F circuit 250 transmits a write command issued by the processor 230 and write data in the buffer memory 240 as the input/output signals I/O to the non-volatile memory 100. During a data read operation, the NAND I/F circuit 250 transmits a read command issued by the processor 230 as the input/output signal I/O to the non-volatile memory 100. Further, the NAND I/F circuit 250 receives data read from the non-volatile memory 100 as the input/output signal I/O, and transmits the read data to the buffer memory 240.

The ECC circuit 260 performs an error detecting process and an error correcting process on data to be stored in the non-volatile memory 100. Thus, during a data write operation, the ECC circuit 260 generates an error correction code, and adds the generated error correction code to write data. During a data read operation, the ECC circuit 260 decodes data to perform the error correction.

[Configuration of Non-Volatile Memory]

Subsequently, the configuration of the non-volatile memory 100 will be described. As illustrated in FIG. 1, the non-volatile memory 100 includes a memory cell array 110, a row decoder 120, a driver 130, a column decoder 140, an address register 150, a command register 160, and a sequencer 170.

The memory cell array 110 includes multiple blocks BLK. Each block BLK includes multiple non-volatile memory cells associated with rows and columns. FIG. 1 illustrates four blocks BLK0 to BLK3 as an example. The memory cell array 110 is able to store data transmitted from the controller 200 in a non-volatile manner.

The row decoder 120 selects one of the blocks BLK0 to BLK3 based on an address ADD in the address register 150, and further, selects a word line WL of the selected block BLK.

The driver 130 generates various voltages, and supplies the voltages to the selected block BLK and word line WL through the row decoder 120, based on a block address BA and a page address PA in the address register 150.

The column decoder 140 includes multiple data latch circuits and multiple sense amplifiers. During a data read operation, each sense amplifier senses data read from the memory cell array 110, and performs a necessary arithmetic process. Then, the column decoder 140 outputs the obtained data DAT to the controller 200 through a data latch circuit (not illustrated). During a data write operation, the column decoder 140 causes the data latch circuit to receive the data DAT from the controller 200, and then, executes the data write operation to the memory cell array 110.

The address register 150 stores an address ADD received from the controller 200. The address ADD includes the block address BA and the page address PA described above.

The command register 160 stores a command CMD received from the controller 200.

The sequencer 170 controls the entire operation of the non-volatile memory 100 based on the command CMD stored in the command register 160.

2. Operation

Subsequently, the operation of the memory system 1 will be described. As described above, in response to a request received from the host device 300, the processor 230 performs a data write operation into the non-volatile memory 100 and a data read operation from the non-volatile memory 100.

Further, the processor 230 executes various processes in the background, separately from the data write operation and the data read operation that are performed in response to a request received from the host device 300. For example, the processor 230 executes a patrol process or the like in the background.

Further, the processor 230 sets the write management unit WMU in the background. Specifically, the processor 230 makes the write management unit WMU of user data conform to the access size of the host device 300. As described above, the write management unit WMU is the smallest unit of the address conversion between a logical address and a physical address in the LUT.

The access size depends on the workload of the host device 300. The access size may be different from the initially estimated workload of the host device 300. Thus, the write management unit WMU is set according to the actual workload.

That is, the memory controller 200 sets the smallest unit of the logical-to-physical address conversion (i.e., the write management unit WMU) when data is written into the non-volatile memory 100, according to the access size designated by the access pattern information. The memory controller 200 sets the smallest unit of the logical-to-physical address conversion (i.e., the write management unit WMU) to conform to the access size.

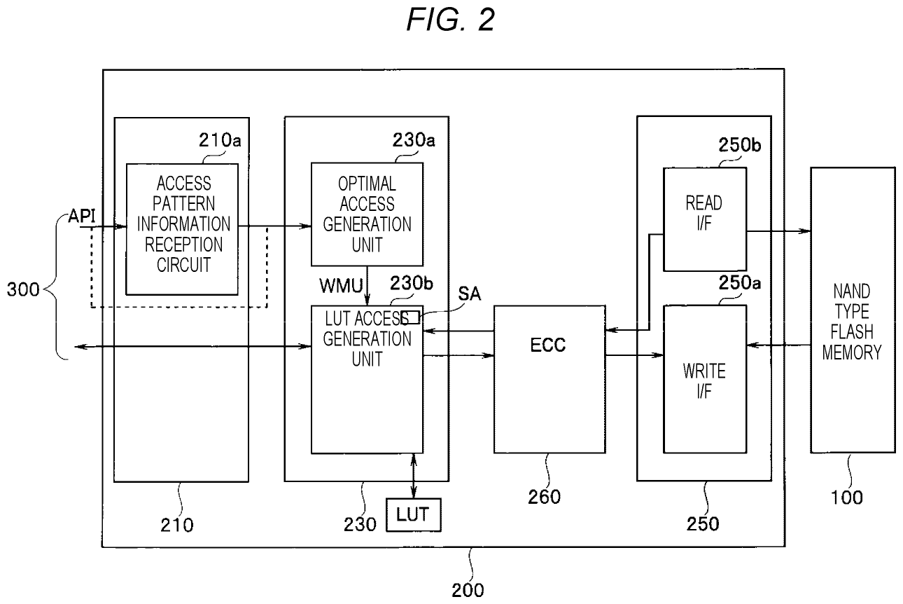

FIG. 2 is a block diagram illustrating a lifetime optimizing process according to the present embodiment. The lifetime optimizing process is a process for optimizing the lifetime of the memory system 1. FIG. 2 illustrates only the functional blocks of the controller 200 that are related to the lifetime optimizing process, and omits the illustration of functional blocks related to other functions.

The host device 300 transmits access pattern information API that corresponds to the workload, to the memory system 1.

The access pattern information reception circuit 210a of the host I/F circuit 210 is connected to at least a portion of signal lines of the host bus. The access pattern information reception circuit 210a is able to receive the access pattern information API from the host device 300 through the host bus. When the access pattern information API is received, the access pattern information reception circuit 210a outputs the access pattern information API to the processor 230. In the present embodiment, the access pattern information API includes the data size (i.e., the access size) when the host device 300 accesses the memory system 1.

The processor 230 functions as an optimal access generation unit 230a and an LUT access generation unit 230b.

When the access pattern information API is received from the access pattern information reception circuit 210a, the optimal access generation unit 230a executes an optimal access generating process. The optimal access generating process is a process of setting or changing the write management unit WMU in the LUT access generation unit 230b, based on the received access pattern information API. In the present embodiment, the optimal access generating process may also be referred to as a write management unit setting process.

In the present embodiment, the timing for executing the write management unit setting process is, for example, a timing when the access pattern information API is received from the host device 300.

The LUT access generation unit 230b includes a storage area SA where information of the write management unit WMU is stored. The write management unit WMU is not changed until new access pattern information API is received.

During a data write operation, the LUT access generation unit 230b generates user data in units of a page (page data), and outputs a write command, a physical address, and the page data to the write interface 250a of the NAND I/F circuit 250 through the ECC 260. The write interface 250a outputs the write command, the physical address, and the page data to the non-volatile memory 100. When the data write operation is executed, the LUT access generation unit 230b updates the LUT. When data written into the non-volatile memory 100 is updated data of data associated with a certain logical address, the LUT access generation unit 230b invalidates the data that has been associated with the logical address (the data previously written into the non-volatile memory 100) for each write management unit WMU.

Here, valid data indicates data associated with a certain logical address. For example, the valid data is data stored in a physical address referred to from the LUT (i.e., the latest data associated with a logical address). The valid data is data that is likely to be read at a later time from the host device 300. The valid data in the cluster size will be referred to as a valid cluster. A block BLK that stores at least one valid data will be referred to as an active block.

Invalid data indicates data that is not associated with any logical address. For example, the invalid data is data stored in a physical address which is not referred to from the LUT. The invalid data is data that seems to be no longer read from the host device 300. When the updated data associated with the certain logical address is written into the non-volatile memory 100, the data that has been associated with the logical address in the meanwhile is invalidated, and the updated data becomes valid data. The invalid data in the cluster size will be referred to as an invalid cluster. A block BLK that includes no valid data will be referred to as a free block.

The processor 230 manages a write mode for each block BLK using a table. The table is stored in, for example, the RAM 220. For example, the processor 230 may write user data into the non-volatile memory 100 in any one write mode among the SLC mode, the MLC mode, the TLC mode, the QLC mode, and the PLC mode, according to a block BLK related to a physical address determined by the LUT access generation unit 230b.

During a data read operation, the LUT access generation unit 230b refers to the LUT, to obtain a physical address of a page that includes user data related to a read request. The LUT access generation unit 230b outputs the obtained physical address and a read command to the read interface 250b of the NAND I/F circuit 250. The read interface 250b outputs the physical address and the read command to the non-volatile memory 100. The LUT access generation unit 230b receives page data read from the non-volatile memory 100 through the ECC 260, extracts the data related to the read request from the page data, and transmits the extracted data to the host device 300.

In FIG. 2, the access pattern information API is received by the access pattern information reception circuit 210a provided in the host I/F circuit 210. However, the processor 230 may receive the access pattern information API from the host device 300. That is, in FIG. 2, as indicated by a dashed line, the processor 230 may receive an access pattern information setting request and the access pattern information API from the host device 300.

Instead of the configuration in which the processor 230 receives the access pattern information API from the host device 300, the processor 230 may analyze a write request from the host device 300, to acquire the access pattern information.

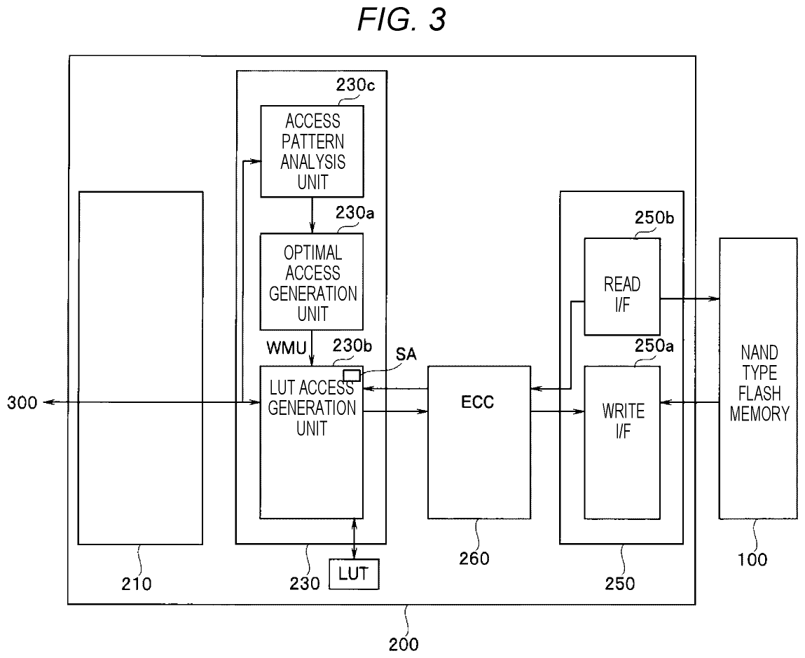

FIG. 3 is a block diagram illustrating a lifetime optimizing process according to a modification of the present embodiment. In the lifetime optimizing process according to the modification, the processor 230 analyzes a write request from the host device 300 to acquire the access pattern information. In FIG. 3, the same components as those in FIG. 2 will be denoted by the same reference numerals as used in FIG. 2, and descriptions thereof will be omitted.

The processor 230 according to the modification functions as an access pattern analysis unit 230c. The access pattern analysis unit 230c analyzes data related to a write request to acquire the access pattern information.

For example, the access pattern analysis unit 230c acquires the size of write data (user data) (represented by, for example, a byte length) included in a write request received by the host I/F circuit 210. As a result, the access pattern analysis unit 230c determines the size of the user data (the access size), and obtains the access pattern information.

For the access pattern information, the access pattern analysis unit 230c may select the minimum value, average value, median value or the like of the sizes of user data (user data lengths) related to multiple write requests, respectively, received for a certain time period. In consideration of the lifetime of the memory system 1, the minimum value among multiple user data lengths may be selected. In this case, the memory controller 200 sets the smallest unit of the logical-to-physical address conversion (i.e., the write management unit WMU) to conform to the smallest size among the sizes of the user data lengths related to the multiple write requests, respectively, received for a certain time period.

The access pattern analysis unit 230c outputs the obtained access pattern information to the optimal access generation unit 230a.

The write management unit setting process according to the modification is, for example, periodically executed.

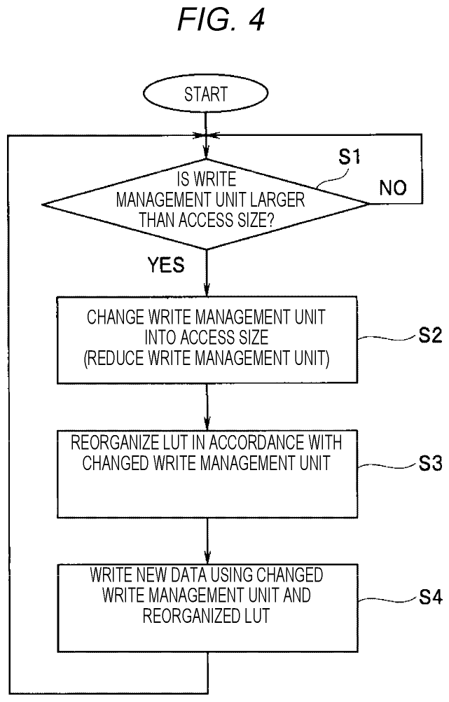

FIG. 4 is a flowchart illustrating an example of a procedure of the write management unit setting process executed by the processor 230. FIG. 4 represents a process performed when the write management unit WMU is set to be smaller.

The optimal access generation unit 230a of the processor 230 acquires the access pattern information API from the access pattern reception circuit 210a or the access pattern analysis unit 230c. The optimal access generation unit 230a determines whether the current write management unit WMU is larger than the access size represented by the acquired access pattern information API (S1).

When it is determined that the current write management unit WMU is not larger than the acquired access size (S1: NO), the processor 230 repeats the determining process of S1.

When it is determined that the current write management unit WMU is larger than the acquired access size (S1: YES), the LUT access generation unit 230b of the processor 230 changes the write management unit WMU into the access size (S2). In S2, the write management unit WMU is changed to be smaller than the write management unit WMU at the time of S1.

The processor 230 reorganizes (or rewrites) the LUT in accordance with the changed write management unit WMU (S3). That is, the LUT is rewritten in accordance with the changed write management unit WMU.

Thereafter, when the controller 200 receives a new write request from the host device 300, the processor 230 writes new data related to the write request into the non-volatile memory 100, using the changed write management unit WMU and the reorganized LUT (S4). After S4, the process returns to S1.

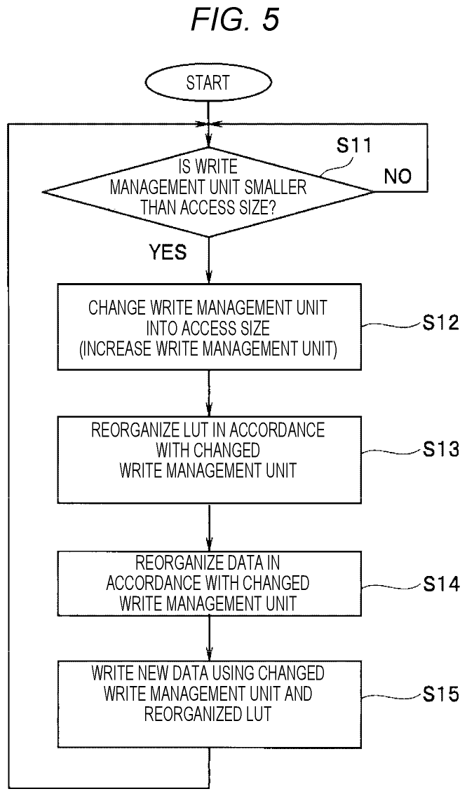

FIG. 5 is a flowchart illustrating another example of a procedure of the write management unit setting process executed by the processor 230. FIG. 5 represents a process performed when the write management unit WMU is set to be larger.

The optimal access generation unit 230a of the processor 230 acquires the access pattern information API from the access pattern reception circuit 210a or the access pattern analysis unit 230c. The optimal access generation unit 230a determines whether the current write management unit WMU is smaller than the access size represented by the acquired access pattern information API (S11).

When it is determined that the current write management unit WMU is not smaller than the acquired access size (S11: NO), the processor 230 repeats the determining process of S11.

When it is determined that the current write management unit WMU is smaller than the acquired access size (S11: YES), the LUT access generation unit 230b of the processor 230 changes the write management unit WMU into the access size (S12). In S12, the write management unit WMU is changed to be larger than the write management unit WMU at the time of S11.

The processor 230 reorganizes (or rewrites) the LUT in accordance with the changed write management unit WMU (S13). That is, the LUT is rewritten in accordance with the changed write management unit WMU.

Further, the processor 230 reorganizes data in accordance with the changed write management unit WMU (S14). That is, when the write management unit WMU is changed to be larger, the memory controller 200 reorganizes the data stored in the non-volatile memory 100 in accordance with the write management unit WMU, after reorganizing the LUT in accordance with the changed write management unit WMU (S14). The reorganization in S14 (user data reorganizing process) will be described later.

Thereafter, when the controller 200 receives a new write request from the host device 300, the processor 230 writes new data related to the write request into the non-volatile memory 100, using the changed write management unit WMU and the reorganized LUT (S15). After S15, the process returns to S11.

In a memory system of a related art, the write management unit WMU is fixed. When a reprograming (rewriting) of user data that corresponds to a certain logical address is executed, old data (i.e., the data of the certain logical address before the reprogramming) is invalidated in the write management unit WMU. Thus, in a case where the size of the user data (the access size) from the host device 300 is smaller than the write management unit WMU in the memory system of the related art, the reprogramming requires that the rest of the user data (the user data that is not to be reprogrammed) included in the same write management unit WMU as the old data be combined with the reprogramming target user data, and the combined data is stored in a page of a different physical address. Since a program-erase (PE) cycle is executed despite that the rest of the user data is not to be rewritten, the lifetime of the memory system may be reduced.

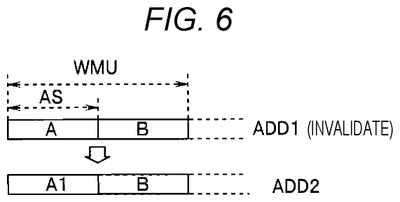

FIG. 6 is a view illustrating a data write operation when the access size is smaller than the write management unit WMU.

It is assumed that an access size AS of the host device 300 is a half of the write management unit WMU of the controller 200. When user data “A” that corresponds to a certain logical address is rewritten as “A1”, the host device 300 outputs the user data “A1” to the controller 200 together with a write request. The controller 200 invalidates the user data of a physical address ADD1 that corresponds to the old user data “A”, and writes the new user data “A1” into another physical address ADD2.

At this time, the invalidation of the data is performed in the write management unit WMU. Thus, as illustrated in FIG. 6, when another user data “B” exists in the data of the write management unit WMU that includes the user data “A1”, the user data “B” that is not to be rewritten is also written into the physical address ADD2. Accordingly, since the program-erase (PE) cycle also occurs for the user data “B”, the lifetime of the memory system is reduced.

Meanwhile, in the present embodiment, since the write management unit WMU conforms to the access size by the process described with reference to FIG. 4, the number of times of unnecessarily writing the user data that is not to be written is reduced. As a result, the reduction of the lifetime of the memory system can be prevented.

Further, when the write management unit WMU is changed to be larger in accordance with the access size by the process described with reference to FIG. 5, data to be consecutively accessed can be made continuous to each other in advance, for improving the efficiency of a subsequent access. That is, when the write management unit WMU is changed to be larger in accordance with the access size, data scattered in the non-volatile memory 100 need to be reorganized to be continuous to each other (S14).

That is, before the write management unit WMU is changed, the user data are scattered because the logical-to-physical address conversion of the user data has been performed in the small data size. Thus, after the write management unit WMU is changed to be larger, the reorganizing process of connecting multiple related data with the small size to each other is executed (S14), so that a data write operation or a data read operation of the user data can be efficiently performed.

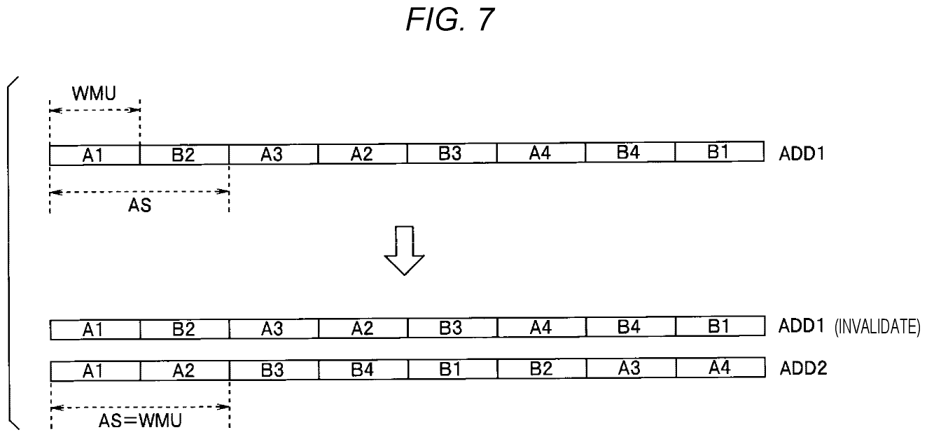

FIG. 7 is a view illustrating a data connecting process in the user data reorganizing process. In FIG. 7, user data “A1” to “A4” have the consecutive logical addresses, and are related to each other. User data “B1” to “B4” have the consecutive logical addresses, and are related to each other. The related data are, for example, data that are read or written at once. Since the logical-to-physical address conversion of the user data has been performed in the small data size before the write management unit WMU is changed to be larger, the user data which are even consecutive data are scattered in the physical address ADD1, as illustrated in the upper portion of FIG. 7. After the write management unit WMU is changed to be larger, the scattered data may be reorganized (organized to be connected to each other), and stored in the new physical address ADD2, so that the efficiency of a subsequent access can be improved. In the user data reorganizing process, a process of invalidating the data in the original physical address ADD1 is performed.

However, in the user data reorganizing process, the process of invalidating the data of the original physical address and the process of writing the data to a new physical address are performed, and thus, the lifetime of the memory system is reduced. Accordingly, the load amount of the user data reorganizing process may be estimated, and when the estimated load amount is large, the user data reorganizing process may not be executed. That is, the user data reorganizing process may be executed only when the process load satisfies a predetermined condition.

According to the embodiment described above, even when the memory system 1 is used in the access size of the workload different from the access size of the initially estimated and defined workload, a predetermined index, for example, TBW (total byte written) or DWPD (drive write per day) may be satisfied. The TBW is an index that represents the total amount of data writable during the lifetime of the memory system 1. The DWPD is the number of times of a drive write per day. For example, when DWPD=10, this means that for an SSD having a 1-Tbyte total capacity, data of 10 Tbytes (=10*1 Tbyte) may be written daily for five years.

Thus, according to the present embodiment, it is possible to provide the memory system capable of optimizing the lifetime thereof according to the access pattern in the workload (the access size (the size of user data related to a write request) in the present embodiment). For example, even when the access size of the workload in the actual use of the memory system is different from the access size of the initially estimated and defined workload, the reduction of the lifetime of the memory system can be prevented.

### Second Embodiment

In the first embodiment, the size of user data is used as the access pattern of the host device 300. Meanwhile, in a second embodiment, an access range of user data is used as the access pattern. The access range is a range of an address value of a logical address of user data in a logical address space.

Among the components of the memory system of the second embodiment, the same components as those of the memory system of the first embodiment will not be described, and different components from those of the memory system of the first embodiment will be described in detail.

The host device 300 performs a data write operation or a data read operation by designating a logical address in the logical address space. For the data write operation, the host device 300 outputs a write request and write data to the memory system 1. Specifically, the controller 200 receives a write command, a head logical address, a data size, and data as the write request.

The controller 200 determines a physical address of the non-volatile memory 100 based on the received logical address and data size.

As described above, the processor 230 executes various processes in the background. The processor 230 also executes a garbage collection (compaction) in the background.

The processor 230 executes the garbage collection in response to a request from the host device 300 or when it is detected that the number of free blocks becomes equal to or less than a predetermined number.

The garbage collection is a process for increasing the number of free blocks. Thus, in the garbage collection, all valid clusters in multiple blocks BLK that include physical blocks in which valid clusters and invalid clusters coexist (referred to as GC-source blocks) are moved to a block BLK in which an erase operation has been completed (referred to as a GC-destination block). All data in the multiple GC-source blocks of which all of the valid clusters have been moved to the GC-destination block are erased. The multiple GC-source blocks in which the erase operation has been completed may be reused as new write destination blocks.

For a narrow range access in which logical addresses of data accessed from the host device 300 falls within a narrow range in the logical address space, all valid data included in a certain block BLK tend to become invalid data (i.e., the corresponding block BLK tends to become a free block) by a data update, and thus, the necessity to perform the garbage collection may hardly occur.

Meanwhile, for a broad range access in which logical addresses of data accessed from the host device 300 extends over a broad range in the logical address space, valid data and invalid data tend to coexist in a certain block BLK (i.e., the corresponding block BLK hardly becomes a free block), and thus, the necessity to perform the garbage collection may likely occur.

Meanwhile, as described above, the controller 200 may perform a data write operation into each block BLK of the non-volatile memory 100 in one write mode among the multiple modes. For example, the controller 200 may write data into each memory cell of each block BLK in any of the SLC mode, the MLC mode, the TLC mode, the QLC mode, and the PLC mode.

In the non-volatile memory 100, as the multi-value degree in the write mode is high (i.e., as the number of bits to be written into each memory cell is large), the number of blocks needed to store the same amount of valid data decreases, and thus, the necessity to perform the garbage collection tends to hardly occur.

Meanwhile, in the non-volatile memory 100, as the multi-value degree in the write mode is low (i.e., as the number of bits to be written into each memory cell is small), the number of blocks needed to store the same amount of valid data increases, and thus, the necessity to perform the garbage collection tends to likely occurs.

Thus, in the present embodiment, in addition to receiving a data write request and performing a data write operation into the non-volatile memory 100, the memory controller 200 sets the multi-value degree in the write mode according to the access pattern (the access range of logical addresses of write data in the present embodiment). When the access pattern (the access range) is the broad range access, the processor 230 performs the data write operation while setting the write mode to the PLC or QLC mode having the high multi-value degree. When the access pattern (the access range) is the narrow range access, the processor 230 performs the data write operation while setting the write mode to the SLC or MLC mode having the low multi-value degree. The processor 230 performs the setting of the write mode, that is, the setting of the multi-value degree in the background.

That is, the processor 230 selects the write mode from the multiple write modes having different multi-value degrees according to the broadness/narrowness of the access range, so as to reduce the necessity to execute the garbage collection. The multi-value degree is set to be high as the access range is broad. For the broad range access, the processor 230 selects the write mode having the high multi-value degree, so as to reduce the necessity to execute the garbage collection. For the narrow range access, the necessity to execute the garbage collection hardly occurs, and thus, the processor 230 may select the write mode having the low multi-value degree. In general, in the write mode having the low multi-value degree, the write performance is high, and the reliability of data written in a block BLK is high.

Further, here, the five write modes (SLC, MLC, TLC, QLC, and PLC) are described. However, the present embodiment may be applied to a case where three write modes (e.g., SLC, MLC, and TLC) are provided. In this case, for the broad range access, the processor 230 sets the write mode to, for example, the TLC mode having the high multi-value degree. Further, for the narrow range access, the processor 230 sets the write mode to, for example, the SLC mode.

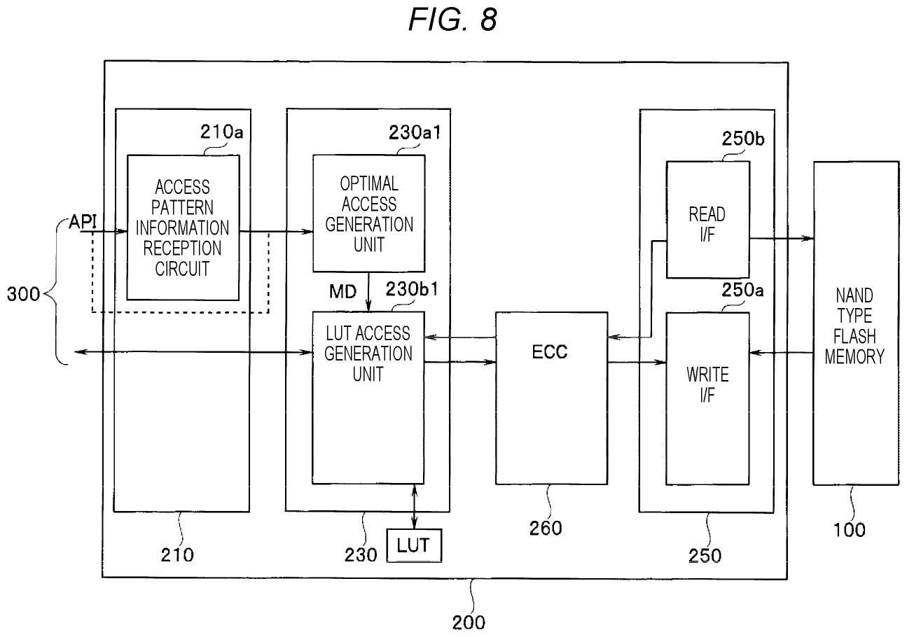

FIG. 8 is a block diagram illustrating the lifetime optimizing process according to the present embodiment. FIG. 8 illustrates only the functional blocks of the controller 200 related to the lifetime optimizing process, and omits the illustration of functional blocks related to other functions.

The host device 300 transmits the access pattern information API that corresponds to the workload, to the memory system 1. That is, the host device 300 notifies the memory system 1 of information that corresponds to an access range of write data as the access pattern information API. Then, when the access pattern information API (the access range information in the present embodiment) is received from the host device 300, the memory system 1 sets the write mode according to the access pattern information API.

Specifically, the processor 230 functions as an optimal access generation unit 230a1 and an LUT access generation unit 230b1. When the access pattern information API is received from the access pattern information reception circuit 210a, the optimal access generation unit 230a1 outputs a write mode signal MD to the LUT access generation unit 230b1. The write mode signal MD is a signal for designating the write mode.

The LUT access generation unit 230b1 performs a data write operation into the non-volatile memory 100 according to the received write mode signal MD. The write mode may be changed in units of a block address.

Further, as in the memory system 1 according to the modification of the first embodiment, the access pattern analysis unit of the processor 230 may determine the access range from the received write request, and may set the write mode according to the determined access range.

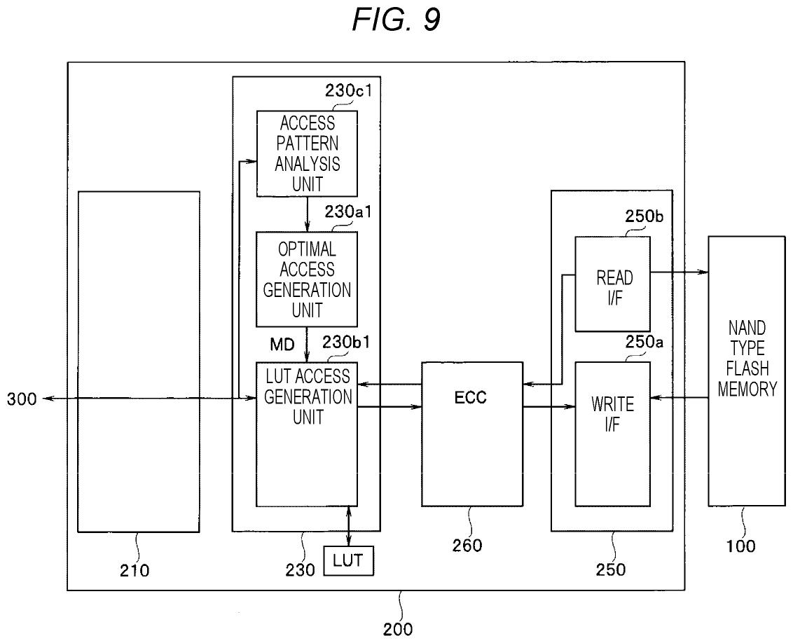

FIG. 9 is a block diagram illustrating a lifetime optimizing process according to a modification of the present embodiment. In the lifetime optimizing process according to the modification, the processor 230 analyzes a write request from the host device 300 to acquire the access pattern information (information on the access range, in the present embodiment). In FIG. 9, the same components as those in FIG. 3 will be denoted by the same reference numerals as used in FIG. 3, and descriptions thereof will be omitted.

The processor 230 according to the modification functions as an access pattern analysis unit 230c1. The access pattern analysis unit 230c1 analyzes data related to the write request to acquire the access pattern information.

Specifically, the access pattern analysis unit 230c1 determines the broadness/narrowness level of the access range of logical addresses of the data related to the write request. For the access range, the access pattern analysis unit 230c1 may determine the minimum value, average value, median value or the like of the access ranges related to multiple write requests, respectively, received for a certain time period. The optimal access generation unit 230a1 sets the write mode according to the determined and obtained access range.

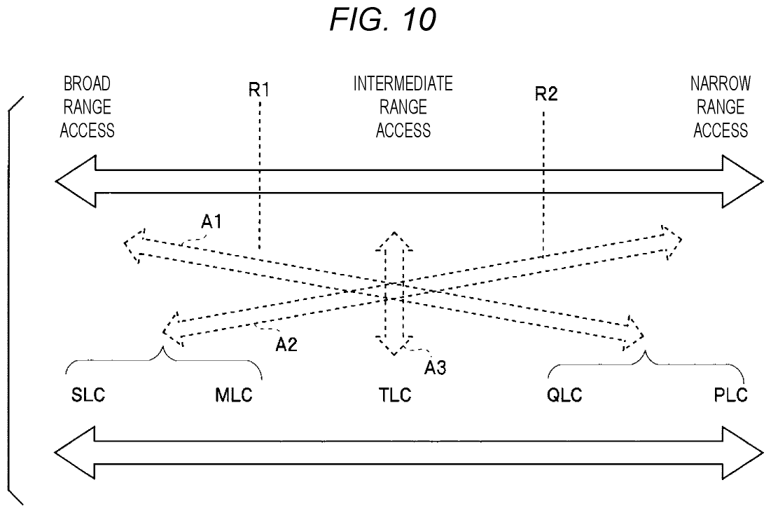

FIG. 10 is a view illustrating an example of a relation between the access range and the write mode. In FIG. 10, when the logical addresses of data related to a write request from the host device 300 extends over a broad range which is equal to or larger than a first range R1 in the logical address space as indicated by a dashed line arrow A1, the write mode is set such that the data is written into the non-volatile memory 100 in the PLC or QLC mode having the high multi-value degree.

Further, when the logical addresses of data related to a write request from the host device 300 extends within a narrow range which is equal to or smaller than a second range R2 (smaller than the first range R1) in the logical address space as indicated by a dashed line arrow A2, the write mode is set such that the data is written into the non-volatile memory 100 in the SLC or MLC mode having the low multi-value degree.

When the logical addresses of data related to a write request from the host device 300 extends within a range which is smaller than the first range R1 and larger than the second range R2 in the logical address space as indicated by a dashed line arrow A3, the write mode is set such that the data is written into the non-volatile memory 100 in the TLC mode.

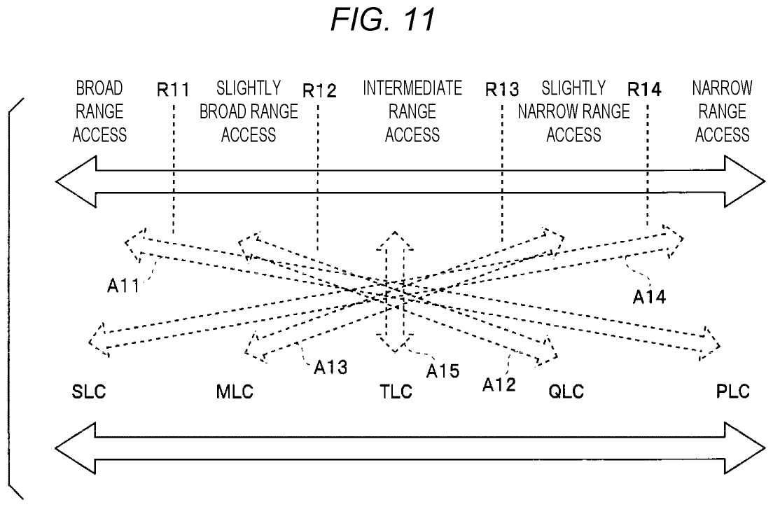

FIG. 11 is a view illustrating another example of the relation between the access range and the write mode. In FIG. 11, when the logical addresses of data related to a write request from the host device 300 extends over a broad range which is equal to or larger than a first range R11 in the logical address space as indicated by a dashed line arrow A11, the write mode is set such that the data is written into the non-volatile memory 100 in the PLC mode having the highest multi-value degree.

Further, when the logical addresses of data related to a write request from the host device 300 extends within a slightly broad range which is equal to or larger than a second range R12 (smaller than the first range R11) and smaller than the first range R11 in the logical address space as indicated by a dashed line arrow A12, the write mode is set such that the data is written into the non-volatile memory 100 in the QLC mode having the high multi-value degree.

Further, when the logical addresses of data related to a write request from the host device 300 extends within a slightly narrow range which is equal to or smaller than a third range R13 (smaller than the second range R12) and larger than a fourth range R14 (smaller than the third range R13) in the logical address space as indicated by a dashed line arrow A13, the write mode is set such that the data is written into the non-volatile memory 100 in the MLC mode having the low multi-value degree.

Further, when the logical addresses of data related to a write request from the host device 300 extends within the smallest range which is equal to or smaller than the fourth range R14 in the logical address space as indicated by a dashed line arrow A14, the write mode is set such that the data is written into the non-volatile memory 100 in the SLC mode having the lowest multi-value degree.

When the logical addresses of data related to a write request from the host device 300 extends within a range which is smaller than the second range R12 and larger than the third range R13 in the logical address space as indicated by a dashed line arrow A15, the write mode is set such that the data is written into the non-volatile memory 100 in the TLC mode.

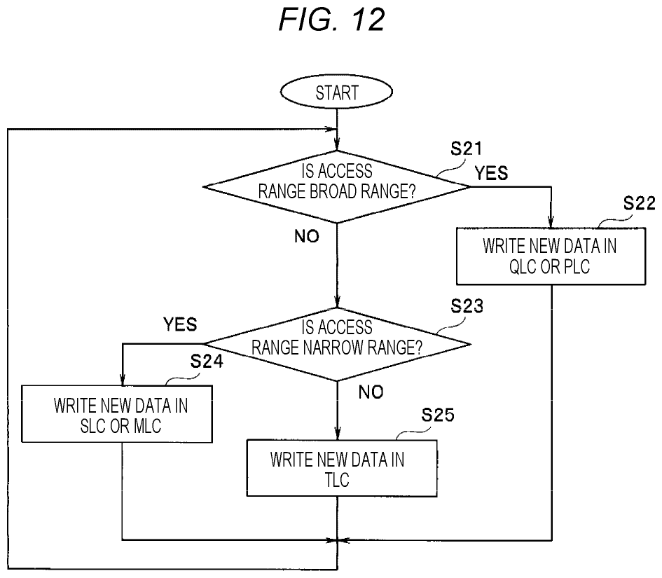

FIG. 12 is a flowchart illustrating an example of the procedure of a write mode setting process performed by the processor 230.

The optimal access generation unit 230a1 of the processor 230 acquires the access pattern information API from the access pattern reception circuit 210a or the access pattern analysis unit 230c1. The optimal access generation unit 230a1 determines whether the access range represented by the acquired access pattern information API is the broad range (S21). When it is determined that the access range is the broad range (S21: YES), the LUT access generation unit 230b1 of the processor 230 writes new data into the non-volatile memory 100 in the QLC or PLC mode (S22).

When it is determined that the access range is not the broad range (S21: NO), the optimal access generation unit 230a1 determines whether the access range is the narrow range (S23). When it is determined that the access range is the narrow range (S23: YES), the processor 230 writes new data into the non-volatile memory 100 in the SLC or MLC mode (S24).

When it is determined that the access range is not the narrow range (S23: NO), the optimal access generation unit 230a1 writes new data into the non-volatile memory 100 in the TLC mode (S25). After S22, S24, or S25, the process proceeds to S21.

According to the embodiment described above, even when the memory system 1 is used in the access range of the workload different from the access range of the initially estimated and defined workload, a predetermined index, for example, TBW (total byte written) or DWPD (drive write per day) can be satisfied.

As described above, according to the present embodiment, it is possible to provide the memory system capable of optimizing the lifetime thereof according to the access range (whether the range of logical addresses of user data related to a write request is broad or narrow). For example, even when the access range of the workload in the actual use of the memory system is different from the access range of the initially estimated and defined workload, the reduction of the lifetime of the memory system can be prevented.

### Third Embodiment

In the first and second embodiments, the access size or the access range of user data is used as each access pattern. Meanwhile, in a third embodiment, a rewrite frequency of user data is used as the access pattern.

Among the components of the memory system of the third embodiment, the same components as those of the memory system of the second embodiment will not be described, and different components from those of the memory system of the second embodiment will be described in detail.

The user data to be written into the memory system 1 may be data with a high rewrite frequency (hereinafter, referred to as hot data) or data with a low rewrite frequency (hereinafter, referred to as cold data).

The host device 300 classifies data to be written into the memory system 1 in advance into the hot data and the cold data. When a data write operation into the non-volatile memory 100 is performed, the processor 230 sets the write mode according to the access pattern (the write frequency in the present embodiment).

That is, in the present embodiment, in addition to receiving a data write request and performing a data write operation into the non-volatile memory 100, the memory controller 200 determines the multi-value degree of each memory cell according to the rewrite frequency which is the access pattern information.

In the present embodiment, the write mode is set according to whether data to be written is the hot or cold data. The multi-value degree is set to be high as the rewrite frequency of data is high. That is, when user data to be written is the hot data, the rewrite frequency of the data is high, and thus, the processor 230 writes the data while setting the write mode to the PLC or QLC mode having the high multi-value degree. Further, when the user data to be written is the cold data, the rewrite frequency of the data is low, and thus, the data needs to be stored for a long time. Thus, the processor 230 writes the data while setting the write mode to the SLC or MLC mode having the low multi-value degree.

The configuration of the memory system of the present embodiment is the same as the configuration described with reference to FIG. 8. However, the access pattern information API that represents whether write data is the hot or cold data is notified from the host device 300 to the memory system 1. The write request includes the access pattern information API that represents whether write data is the hot or cold data.

Further, in the present embodiment as well, the processor 230 may monitor write data from the host device 300, so as to determine whether the write data is the hot or cold data. In this case, the configuration of the memory system is the same as the configuration illustrated in FIG. 9. For example, the access pattern analysis unit 230c1 monitors the logical address related to a write request, and when the number of times of writing data of the same logical address is equal to or more than a first predetermined number within a predetermined time period, the access pattern analysis unit 230c1 determines that the data of the logical address is the hot data. Further, when the number of times of writing data of the same logical address is less than a second predetermined number within a predetermined time period, the access pattern analysis unit 230c1 determines that the data of the logical address is the cold data.

The information of the determination result as to whether the write data is the hot or cold data may be stored in, for example, the RAM 220. The information of the determination result includes, for example, information representing whether data of each logical address is the hot or cold data. Accordingly, when a write request is received, the optimal access generation unit 230a1 may refer to the information of the determination result to determine the write mode.

The optimal access generation unit 230a1 receives the access pattern information API from the access pattern reception circuit 210a or the access pattern analysis unit 230c1. The optimal access generation unit 230a1 outputs the write mode signal MD that corresponds to the access pattern information API to the LUT access generation unit 230b1.

Since the hot data is rewritten immediately after being written, the memory system 1 does not need to store the hot data for a long time period. That is, the reliability of the hot data stored in the non-volatile memory 100 may be relatively low. Accordingly, the hot data is written into the non-volatile memory 100 in the write mode having the high multi-value degree such as the PLC mode, the QLC mode or the like.

The cold data is data that is written infrequently. The memory system 1 needs to store the cold data for a long time period. That is, the reliability of the cold data stored in the non-volatile memory 100 needs to be relatively high. Accordingly, the processor 230 writes the cold data into the non-volatile memory 100 in the write mode having the low multi-value degree such as the SLC or MLC mode.

When write data is neither the hot data nor the cold data, the processor 230 writes the data into the non-volatile memory 100 in the TLC mode.

Further, two levels may be provided for each of the hot data and the cold data, such that, for example, when the level of the hot data is a level H1 having the highest rewrite frequency, the PLC mode having the highest multi-value degree is set as the write mode, and when the level of the hot data is a level H2 having the second highest rewrite frequency, the QLC mode having the second highest multi-value degree is set as the write mode. When the level of the cold data is a level C1 having the lowest rewrite frequency, the SLC mode having the lowest multi-value degree may be set as the write mode, and when the level of the cold data is a level C2 having the second lowest rewrite frequency, the MLC mode having the second lowest multi-value degree may be set as the write mode. When write data is not any of the levels H1, H2, C1, and C2, the processor 230 writes the data into the non-volatile memory 100 in the TLC mode.

The information of whether write data is the hot or cold data is managed by table data in the RAM 220 for each logical address. The table data includes information representing whether data of each logical address is the hot or cold data.

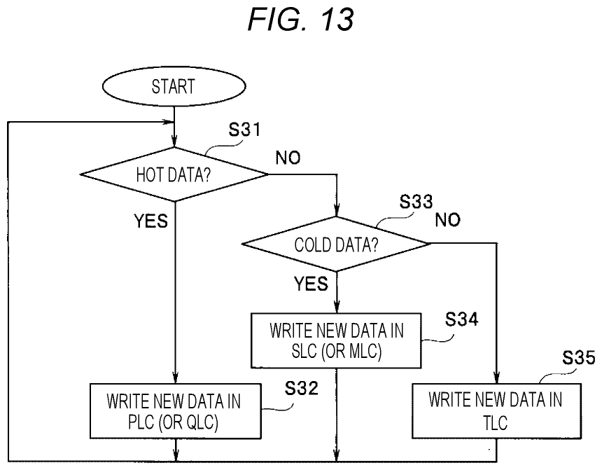

FIG. 13 is a flowchart illustrating an example of the procedure of the write mode setting process performed by the processor 230.

The optimal access generation unit 230a1 of the processor 230 acquires the access pattern information API from the access pattern reception circuit 210a or the access pattern analysis unit 230c1. The optimal access generation unit 230a1 determines whether write data represented by the acquired access pattern information API is the hot data (S31).

When it is determined that the write data is the hot data (S31: YES), the processor 230 sets the write mode to the PLC or QLC mode, and writes new data into the non-volatile memory 100 in the PLC or QLC mode (S32).

When it is determined that the write data is not the hot data (S31: NO), the optimal access generation unit 230a1 determines whether the write data is the cold data (S33).

When it is determined that the write data is the cold data (S33: YES), the processor 230 sets the write mode to the SLC or MLC mode, and writes new data into the non-volatile memory 100 in the SLC or MLC mode (S34).

When it is determined that the write data is not the cold data (S33: NO), the processor 230 sets the write mode to the TLC mode, and writes new data into the non-volatile memory 100 in the TLC mode (S35).

Accordingly, in the memory system 1, when user data is the hot data, the processor 230 writes the user data into the non-volatile memory 100 in the PLC mode (or the QRC mode). Further, when user data is the cold data, the processor 230 writes the user data into the non-volatile memory 100 in the SLC mode (or the MLC mode).

Further, even though the user data is the hot data, the processor 230 may write the user data into the non-volatile memory 100 in the SLC mode (or the MLC mode) when the writing speed is important.

Further, the write mode may be set according to the importance of data (the temporality in this case). The temporality relates to a data retention time period, such that data which needs to be stored for a short time period has the low importance, and data which needs to be stored for a long time period has the high importance.

For example, when user data received from the host device 300 is primary data having the low importance (e.g., cache data), the memory controller 200 writes the user data into the non-volatile memory 100 in the SLC mode (or the MLC mode). When user data received from the host device 300 is not the primary data, the memory controller 200 writes the user data into the non-volatile memory 100 in the PLC mode (or the QLC mode).

In the example described above, the write mode is set according to whether write data is the hot data (or the cold data) or according to the importance of the write data. However, a criterion may be set to determine whether to perform a refresh write in a patrol operation. That is, in addition to receiving a data write request and performing a data write operation into the non-volatile memory 100, the memory controller 200 may change the criterion for the refresh write in a patrol read for the non-volatile memory 100 according to the access pattern (the rewrite frequency or the importance of data). The criterion is set such that the refresh write is hardly performed when the rewrite frequency of data is high or the importance of data is low.

When it is determined that the refresh write of data is necessary as a result of the patrol read, the data is written into another page and the existing data is invalidated. However, the writing of the same data causes the reduction of the lifetime of the memory system.

Accordingly, in the present embodiment, for the hot data or non-important data, the criterion level for the refresh write may be raised such that the refresh write is hardly performed. As a result, the reduction of the lifetime of the memory system may be prevented.

According to the embodiment described above, even when the memory system 1 is used with the data rewrite frequency of the workload different from the data rewrite frequency of the initially estimated and defined workload, a predetermined index, for example, TBW (total byte written) or DWPD (drive write per day) may be satisfied.

As described above, according to the present embodiment, it is possible to provide the memory system capable of optimizing the lifetime thereof according to the access pattern in the workload (e.g., whether data is the hot data, in the present embodiment). For example, even when the data rewrite frequency of the workload in the actual use of the memory system is different from the data rewrite frequency of a predetermined workload, the reduction of the lifetime of the memory system can be prevented.

### Fourth Embodiment

In the first, second, and third embodiments, the access size, the access range, and the rewrite frequency of user data are each used as the access pattern of the host device 300. Meanwhile, in a fourth embodiment, a flush request pattern is used as the access pattern.

Among the components of the memory system of the fourth embodiment, the same components as those of the memory system of the first embodiment will not be described, and different components will be described in detail.

The buffer memory 240 temporarily stores data until the amount of the stored data exceeds a predetermined amount TH. When the amount of data stored in the buffer memory 240 exceeds the predetermined amount TH, the write process into the non-volatile memory 100 is executed. As a result of the write process, the data accumulated in the buffer memory 240 are brought into a non-volatile state.

However, when the power supplied to the memory system 1 is turned off in a state where data is temporarily stored in the buffer memory 240, the data is lost because the buffer memory 240 is a volatile memory. As a result, a state occurs in which data requested to be written by the host device 300 is not written in the non-volatile memory 100 (hereinafter, referred to as a roll-back phenomenon). Thus, an allowable amount AM for allowing the occurrence of the roll-back phenomenon (a roll-back allowable amount) is defined in the specification of the memory system 1.

Meanwhile, the host device 300 may transmit a flush request (a flush command) to the memory system 1. The flush request is a command for requesting that data accumulated in the buffer memory 240 be forcibly written into the non-volatile memory 100 (i.e., requesting to perform a non-volatilization), regardless of the amount of data accumulated in the buffer memory 240.

When the flush request is received, the memory system 1 performs a flush process. As a result of the flush process, the data accumulated in the buffer memory 240 are forcibly written into the non-volatile memory 100, regardless of the amount of the data. In other words, the flush request requests the memory system 1 to execute a non-volatilization process for all of the data that are stored in the buffer memory 240 but have not yet been written into the non-volatile memory 100. For example, the host device 300 may periodically transmit the flush request to the memory system 1, so as to prevent the above-described roll-back phenomenon.

However, when the flush request is frequently executed, and when the size of data in the flush process is less than the predetermined amount TH, the lifetime of the memory system is eventually reduced.

Further, as also described in the first embodiment with reference to FIG. 6, when the data “A” to be written by the flush request is smaller than the write management unit WMU, the program-erase (PE) cycle occurs for the data “B” that does not have to be rewritten, and thus, the lifetime of the memory system is further reduced.

Thus, in the present embodiment, even when the flush request is received, the memory system 1 does not execute the flush process in a case where the amount of data accumulated in the buffer memory 240 is equal to or less than a predetermined threshold. Further, when the flush request is received, the memory system 1 executes the flush process in a case where the amount of data accumulated in the buffer memory 240 exceeds the predetermined threshold. In the present embodiment, the predetermined threshold is the allowable amount AM.

That is, when a request for writing data into the non-volatile memory 100 is received, the memory controller 200 temporarily stores the data in the buffer memory 240. When the amount of data stored in the buffer memory 240 exceeds the predetermined amount TH, the memory controller 200 performs a write process of writing the data stored in the buffer memory 240, into the non-volatile memory 100. Further, when the flush request is received from the host device 300, the memory controller 200 controls the execution of the flush process according to the amount of the data stored in the buffer memory 240.

When the amount of the data stored in the buffer memory 240 at the time when the flush request is received is equal to or less than the allowable amount AM, the memory controller 200 does not execute the flush process. When the amount of the data exceeds the allowable amount AM at the time when the flush request is received, the memory controller 200 executes the flush process. Here, the allowable amount AM is set based on an amount that may allow data stored in the buffer memory 240 not to be non-volatilized when the power supplied to the memory system 1 is turned off.

The processor 230 may execute the flush process for performing the non-volatilization of the data stored in the buffer memory 240, in the background. The timing for executing the flush process is controlled according to the amount of the data stored in the buffer memory 240.

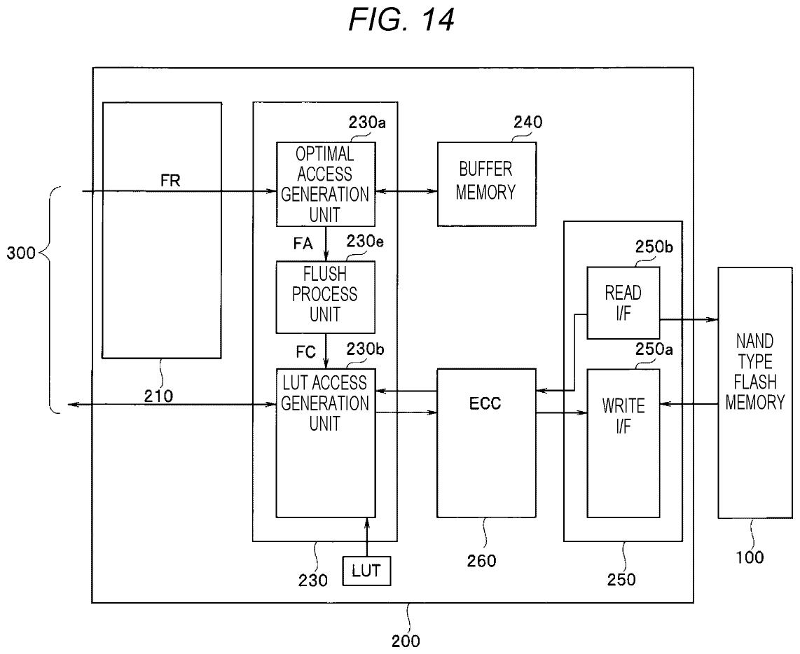

FIG. 14 is a block diagram illustrating the lifetime optimizing process according to the present embodiment. FIG. 14 illustrates only the functional blocks of the controller 200 related to the lifetime optimizing process, and omits the illustration of functional blocks related to other functions.

The host device 300 transmits a flush request FR to the memory system 1 at a predetermined timing.

The processor 230 functions as a flush process unit 230e. When the flush request FR is received from the host device 300, the optimal access generation unit 230a determines whether to output a command FA for instructing the flush process unit 230e to execute the flush process.

The optimal access generation unit 230a compares the amount of data stored in the buffer memory 240 with the allowable amount AM. When the amount of the stored data exceeds the allowable amount AM, the optimal access generation unit 230a outputs the command FA to the flush process unit 230e. When the amount of the stored data is equal to or less than the allowable amount AM, the optimal access generation unit 230a does not output the command FA to the flush process unit 230e.

When the command FA is received, the flush process unit 230e outputs a flush command FC to the LUT access generation unit 230b. When the flush command FC is received, the LUT access generation unit 230b performs the non-volatilization of the data stored in the buffer memory 240.

In the example described above, when the flush request FR is received, the execution of the flush process is controlled by comparing the amount of the data accumulated in the buffer memory 240 with the allowable amount AM. However, the execution of the flush process may be controlled using a power-on guaranteed time of the memory system 1, instead of the allowable amount AM.

The power-on guaranteed time is a time for which the power supplied to the memory system 1 is guaranteed. When the flush request is received, the amount of data stored in the buffer memory 240 is compared with the data amount that corresponds to the power-on guaranteed time. When the amount of data stored in the buffer memory 240 is equal to or less than the amount of data that can be non-volatilized within the power-on guaranteed time using the power supplied from a power storage device (not illustrated) provided in the memory system 1, the memory system 1 does not execute the flush process. When the amount of data stored in the buffer memory 240 exceeds the amount of data that can be non-volatilized within the power-on guaranteed time using the power supplied from the power storage device, the memory system 1 executes the flush process.

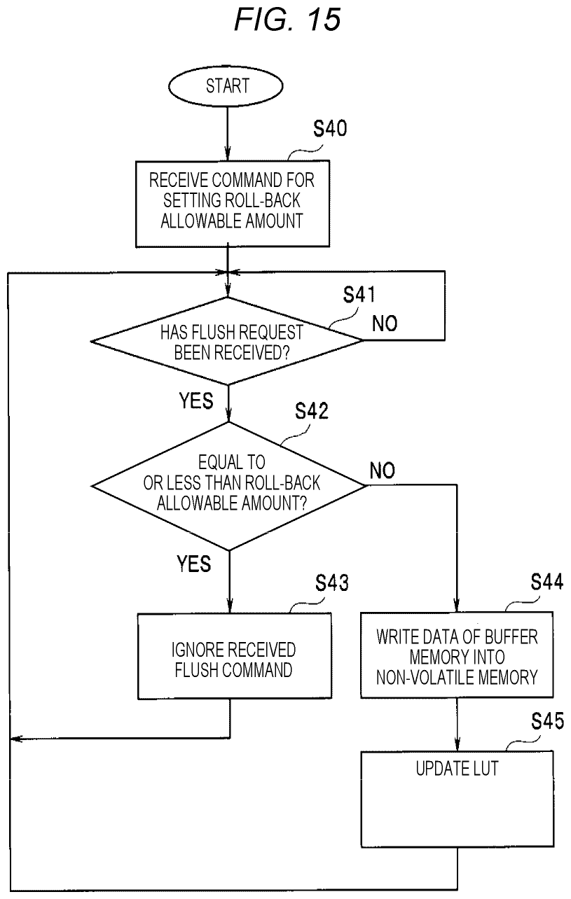

FIG. 15 is a flowchart illustrating an example of the procedure of the flush process performed by the processor 230. In the flush process according to the present embodiment, it is determined whether the amount of data in the buffer memory 240 is equal to or less than the roll-back allowable amount.

The processor 230 receives a command for setting the roll-back allowable amount from the host device 300 (S40). The processor 230 determines whether the flush request has been received from the host device 300 (S41). When it is determined that the flush request has not been received (S41: NO), the processor 230 repeats the determination of S41.

When it is determined that the flush request has been received (S41: YES), the processor 230 determines whether the amount of data of the buffer memory 240 is equal to or less than the roll-back allowable amount (S42).

When it is determined that the amount of the data of the buffer memory 240 is equal to or less than the roll-back allowable amount (S42: YES), the processor 230 ignores the received flush request (S43), and the process proceeds to S41.

When it is determined that the amount of the data of the buffer memory 240 exceeds the roll-back allowable amount (S42: NO), the processor 230 writes the data of the buffer memory 240 into the non-volatile memory 100 (S44). Thereafter, the processor 230 updates the LUT (S45). After S45, the process proceeds to S41.

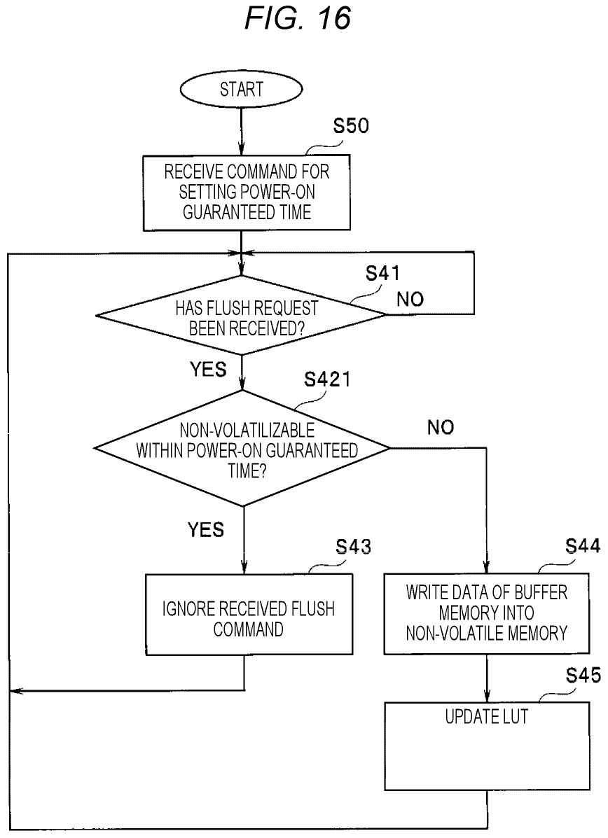

FIG. 16 is a flowchart illustrating another example of the procedure of the flush process performed by the processor 230. In the flush process according to a modification of the present embodiment, it is determined whether the data of the buffer memory 240 can be non-volatilized within the power-on guaranteed time.

In FIG. 16, the same steps as those in FIG. 15 are denoted by the same step numbers as used in FIG. 15.

The processor 230 receives a command for setting the power-on guaranteed time from the host device 300 (S50). When the flush request is received (S41: YES), the processor 230 determines whether the data of the buffer memory 240 can be non-volatilized within the power-on guaranteed time (S421).

When it is determined that the data of the buffer memory 240 cannot be non-volatilized within the power-on guaranteed time (S421: NO), the processor 230 writes the data of the buffer memory 240 into the non-volatile memory 100 (S44). The other steps are the same as those in FIG. 15.

According to the embodiment described above, even when the memory system is used in the flush request pattern of the workload different from the flush request pattern of the initially estimated and defined workload, a predetermined index, for example, TBW (total byte written) or DWPD (drive write per day) can be satisfied.

As described above, according to the present embodiment, it is possible to provide the memory system capable of optimizing the lifetime thereof according to the access pattern (the flush request pattern in the present embodiment) in the workload. For example, even when the flush request pattern of the workload in the actual use of the memory system is different from the flush request pattern of a predetermined workload, the reduction of the lifetime of the memory system can be prevented.

According to each embodiment described above, it is possible to provide the memory system capable of optimizing the lifetime thereof according to the access pattern.

Further, in each embodiment described above, the write management unit setting process, etc., is executed when the access pattern information is received from the host device 300, or when the access pattern information is acquired through an analysis. However, the process may be executed at a predetermined timing after the access pattern information is received or acquired through the analysis. For example, the timing for executing the write management unit setting process may be a timing designated by an instruction signal for instructing the execution of the write management unit setting process that is separately received from the host device 300, after the access pattern information including the access size is received, or after the access size is detected by the access pattern analysis unit 230c.

Further, the timing for executing the write management unit setting process may be a timing set based on the lifetime of the memory system 1. For example, the execution timing may be a timing of a predetermined value in the index of the write lifetime of the memory system 1, for example, a timing that corresponds to a 10% interval of the lifetime of the memory system 1.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a non-volatile memory; and
a memory controller configured to:
receive a write request for data; and
determine a unit of a logical-to-physical address conversion which is a conversion between a logical address associated with the data and a physical address of the non-volatile memory into which the data is to be written, according to a size of the data.

2. The memory system according to claim 1, wherein the memory controller is configured to determine the unit of the logical-to-physical address conversion to conform to the size of the data.

3. The memory system according to claim 1, wherein the memory controller is configured to determine the unit of the logical-to-physical address conversion to conform to a smallest size among sizes of the data designated by a plurality of write requests received during a time period.

4. The memory system according to claim 1, wherein the memory controller is configured to:
according to changing the unit of the logical-to-physical address conversion from a first unit into a second unit larger than the first unit,
reorganize a logical-to-physical address conversion table for performing the logical-to-physical address conversion in accordance with the second unit;
read data stored in the non-volatile memory; and
write the read data into the non-volatile memory such that a logical address associated with the read data is converted into a physical address of the non-volatile memory in the second unit.

5. The memory system according to claim 1, wherein the memory controller is configured to:
according to changing the unit of the logical-to-physical address conversion from a first unit into a second unit smaller than the first unit,
reorganize a logical-to-physical address conversion table for performing the logical-to-physical address conversion in accordance with the second unit; and
write new data into the non-volatile memory such that a logical address associated with the new data is converted into a physical address of the non-volatile memory in the second unit.

6. The memory system according to claim 1, wherein the memory controller is configured to determine the unit of the logical-to-physical address conversion to conform to an average size among sizes of the data designated by a plurality of write requests received during a time period.

7. The memory system according to claim 1, wherein the memory controller is configured to determine the unit of the logical-to-physical address conversion to conform to a median size among sizes of the data designated by a plurality of write requests received during a time period.

8. A memory system comprising:
a non-volatile memory including a memory cell; and
a memory controller configured to:
receive a write request for writing data into the memory cell; and
determine a multi-value degree of the memory cell, according to a range of logical addresses of the data that is designated by the write request or a rewrite frequency of the data.

9. The memory system according to claim 8, wherein the memory controller is configured to:
when the range of the logical addresses is within a first range, determine the multi-value degree as a first value; and
when the range of the logical addresses is within a second range larger than the first range, determine the multi-value degree as a second value larger than the first value.

10. The memory system according to claim 8, wherein the memory controller is configured to:
when the rewrite frequency is a first frequency, determine the multi-value degree as a first value; and
when the rewrite frequency is a second frequency higher than the first frequency, determine the multi-value degree as a second value larger than the first value.

11. The memory system according to claim 8, wherein the multi-value degree includes the number of bits to be stored in the memory cell.

12. A memory system comprising:
a non-volatile memory;
a volatile data buffer; and
a memory controller configured to, in response to receiving a flush request for writing data stored in the volatile data buffer into the non-volatile memory, determine whether to execute a flush process related to the flush request according to an amount of the data stored in the volatile data buffer.

13. The memory system according to claim 12, wherein the memory controller is configured to:
when the amount of the data stored in the volatile data buffer is equal to or less than a predetermined threshold, not execute the flush process; and
when the amount of the data is greater the predetermined threshold, execute the flush process.

14. The memory system according to claim 13, further comprising:
a power storage device,
wherein the memory controller is configured to:
in response to receiving a first command, set the predetermined threshold based on an amount designated by the first command.

15. The memory system according to claim 13, further comprising:
a power storage device,
wherein the memory controller is configured to:
in response to receiving a second command, set the predetermined threshold based on an amount in which the data stored in the volatile data buffer is non-volatilized using a power supplied from the power storage device within a power-on guaranteed time designated by the second command after a supply of the power to memory system is turned off.
